(19) United States
(12) Patent Application Publication
(10) Pub. No.: US 2002/0189898 A1
(43) Pub. Date: Dec. 19, 2002

(54) Scaffolding safety device

(76) Inventor: Adam Campbell, Allerton Bywater (GB)

Correspondence Address: VENABLE, BAETJER, HOWARD AND CIVILETTI, LLP, P.O. BOX 34385, WASHINGTON, DC, 20043-9998, US

(21) Appl. No.: 10/168,078

(22) PCT Filed: Nov. 29, 2000
(86) PCT No.: PCT/GB00/04563

(30) Foreign Application Priority Data
Dec. 17, 1999 (GB) 9929814.3
Sep. 25, 2000 (GB) 0023405.4

(51) Int. Cl. A62B 1/16

(52) U.S. Cl. 182/3

(57) ABSTRACT

A scaffolding safety device 10 comprises a clamping portion 12 and an eyelet portion 14. The clamping portion 12 is arranged to be clamped to a scaffolding pole, either an upright standard pole or a horizontal ledger pole. The clamping portion 12 has a tether 16 secured thereto, which tether 16 is secured to a harness 18 worn by a worker.

### FIELD OF THE INVENTION

This invention relates to a scaffolding safety device.

### BACKGROUND OF THE INVENTION

An existing method of protecting a construction worker in the event that he falls from a scaffolding involves clipping a carabiner, secured by a cord or tape to a harness worn by the worker, to a horizontal ledger of the scaffolding. In order for this system to work correctly, there must be a free horizontal ledger above the worker for the worker to clip the carabiner to. Consequently, it is necessary in all scaffolding to extend the scaffolding above the working level so that there is a horizontal bar above the worker on to which he can clip his carabiner. This has disadvantages because the cost of erecting a scaffold and the time taken is increased because the greater height of scaffolding is needed to allow the workers to work safely on the scaffolding.

Another existing method of protecting a worker on scaffolding involves the use of an inertia block which is also clipped to a horizontal ledger of the scaffolding. The inertia block has an extendible cord which can be fed out slowly from the inertia block but, in the event of a sudden tension on the block, for example, if a worker falls, the inertia block locks, in much the same way as an existing seat belt would. Disadvantages are also encountered with this type of device, because of the need for a horizontal ledger, as mentioned above, above the worker.

It is an object of the present invention to address the above mentioned disadvantages.

### SUMMARY OF THE INVENTION

According to one aspect of the present invention a scaffolding safety device comprises a clamping portion and an attachment portion, wherein the clamping portion is operable to be removably secured to a scaffolding pole and the attachment portion is operable to receive a tether for tethering a worker to the scaffolding safety device, and in which the clamping portion and the attachment portion are rigidly linked together.

The clamping portion may be a clamp section of an existing scaffolding clamp. The clamping portion may be an existing scaffolding clamp comprising two separate pivotally mounted clamp sections. In which case the attachment portion may project from one clamp section or from between the two clamp sections.

The clamping portion may comprise pivotable jaws which may be securable to a scaffolding pole with locking means. The locking means may be a threaded nut and bolt. The clamping portion may be operable to be clamped to a scaffolding pole, with one jaw on one side of the pole and another jaw on another side of the pole.

The clamping portion may be operable to be clamped between sections of the scaffolding, preferably between cup portions of the scaffolding, as in a cup lock system. The clamping portion may comprise a plate to be clamped relative to the scaffolding, preferably between upper and lower cups.

The attachment portion may comprise a closed loop which, may have a hinged opening. The hinged opening may be lockable. The attachment portion may have smooth edges. The attachment portion may have a generally smooth, preferably approximately circular, cross-section.

The tether may be a lanyard, preferably a tape or rope lanyard, attachable to a worker's harness. The lanyard may be captive on the attachment portion. The lanyard may be a part of the scaffolding safety device. The tether may have a closed loop, for attachment to the attachment portion by means of the hinged opening therein.

The safety device may be made of steel. The safety device may be drop-forged.

The safety device may be operable to be secured to a generally vertically orientated scaffolding pole. The safety device may be operable to be secured to a scaffolding pole orientated at an angle to the horizontal. The safety device may be operable to be secured to a generally horizontal scaffolding pole.

A specific embodiment of the present invention will now be described, by way of example, and with reference to the accompanying drawings, in which:

### BRIEF DESCRIPTION OF THE FIGURES

FIG. 1 is a schematic rear view of a scaffolding safety device;

FIG. 2 is a schematic side view of the scaffolding safety device;

FIG. 3 is a schematic partial view of the scaffolding safety device in use;

FIG. 4 is a schematic view of an alternative form of eyelet for the device; and

FIG. 5 is an exploded schematic view of an alternative type of clamping portion for the device.

### DETAILED DESCRIPTION OF A PREFERRED EMBODIMENT

A scaffolding safety device 10 comprises a clamping portion 12 and an eyelet portion 14. The clamping portion 12 is arranged to be clamped to a scaffolding pole, either an upright standard pole or a horizontal ledger pole. The clamping portion 12 has a tether 16 (see FIG. 3) secured thereto, which tether 16 is secured to a harness 18 worn by a worker.

In more detail, the clamping portion 12 comprises a known clamping portion 12 from an existing scaffolding clamp. The clamping portion 12 comprises a first jaw 20 which is pivotally attached to a second jaw 22. A pivot 24 permits relative pivoting of the first and second jaws 20 and 22.

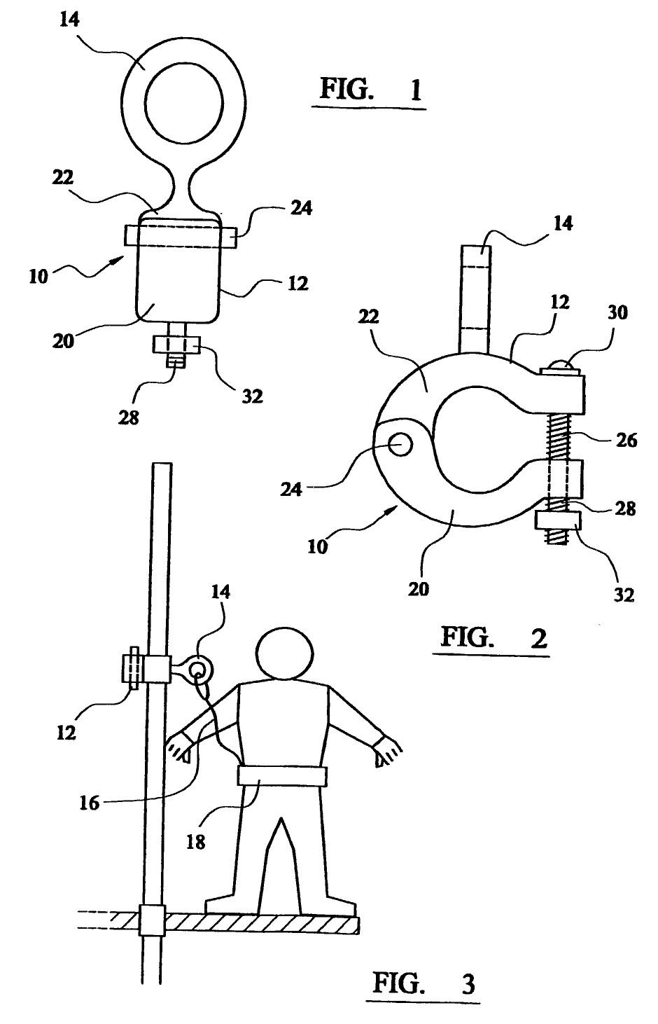

A mouth 26 of the clamping portion 12 is closed by a threaded bolt 28 which is held captive in the second jaw 22 in an opening (not shown) through which a head 30 of the bolt 28 cannot pass. An opposite end of the bolt 28 is received in a U-shaped opening (not shown) of the first jaw 20 as shown in FIG. 2. A nut 32 can be tightened on the bolt 28 to lock the first jaw 20 relative to the second jaw 22 about a scaffolding pole, as shown in FIG. 3. These elements of the clamping portion 12 are all well known from prior art scaffolding clamps.

The eyelet portion 14 is secured to the second jaw 22 and projects at approximately a right angle therefrom. The eyelet portion 14 can be secured to the first jaw 20 by welding or by means of a threaded projection received in a correspondingly tapped opening.

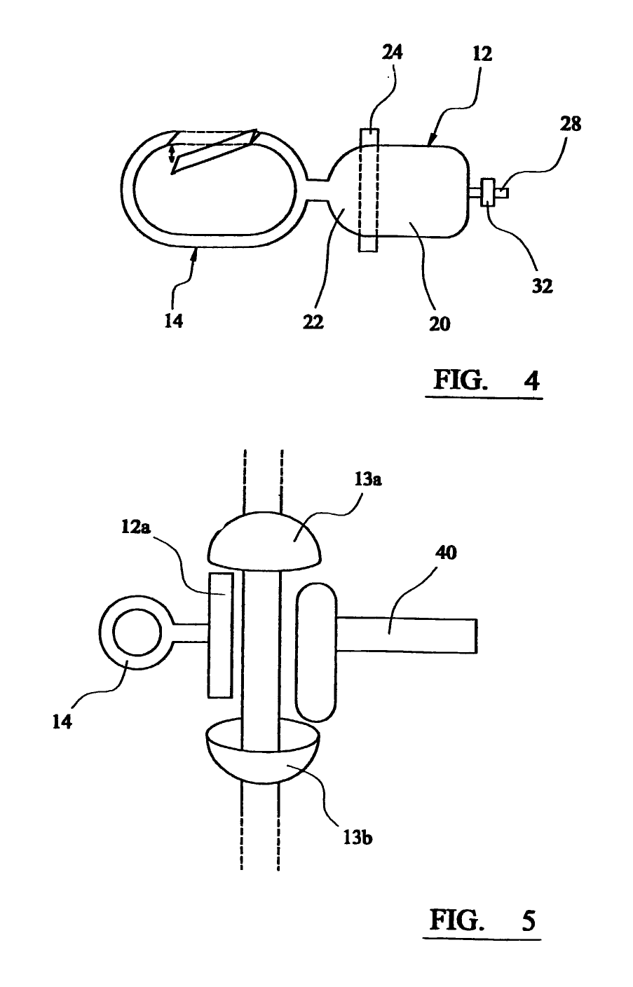

The eyelet portion 14 has a smooth surface to receive the tether 16 and to allow movement of the tether about the eyelet 14 without causing unnecessary abrasion thereof. The eyelet portion 14 may have a hinged opening to allow a closed loop of a lanyard to be clipped to the eyelet portion 14—see FIG. 4.

The eyelet may have a circular cross-section.

In use, the scaffolding safety device 10 is secured to the harness 18 of a worker by means of the tether 16. When the worker is working above the ground, the clamping portion 12 the first jaw 20 of the clamping portion 12 is opened and is placed around a vertical standard or a horizontal ledger and is clamped in position by tightening the nut 32. The worker is then protected from a fall, because the clamping portion 12 will not move relative to the scaffolding pole, given that it is tightened in position. Thus, even when the worker is working at the top of a scaffolding and there are no horizontal ledgers above him, he can secure the clamping portion 12 to a vertical standard and still work in safety.

A worker may have two scaffolding safety devices secured by separate tethers 16 to his harness 18. In this situation when he wishes to move across a scaffolding, he can attach one scaffolding safety device 10 to a scaffolding pole whilst the other scaffolding safety device is being moved into position. The first device can then be removed to allow greater freedom of movement for the worker. In this situation, there will always be one scaffolding safety device 10 secured to the scaffolding, to ensure the worker is safe.

An alternative embodiment of the scaffolding safety device comprises a standard scaffolding clamp, which comprises two clamping portions which are pivotally secured together. The two clamping portions correspond to the clamping portion 12 of the first embodiment and are pivotally connected together at their first jaws 20 by a pin. The second embodiment of a scaffolding safety device further comprises an eyelet 14 which extends from one of the two clamping portions or from the joining pin. The second embodiment has advantages in that it can still be used as a standard scaffolding clamp to clamp two scaffolds together but also may additionally be used as a scaffolding safety device as described above in relation to the first embodiment. Furthermore, a user of the second embodiment may attach a tether 16 or lanyard to the eyelet 14 projecting from a scaffolding clamp which is in use to hold two scaffolding poles together.

A further embodiment is shown in FIG. 5. In this embodiment, the clamping portion 12a is a plate which is secured between two cups 13a/b of a cup lock scaffolding system. The cups 13a/b are usually used to hold scaffolding poles together. FIG. 5 shows the system in an exploded view for ease of understanding. In use the plate 12a is retained in position by the cups 13a/b which, would be moved together from the position in FIG. 5 to retain a pole 40 and the device 10 in position. The eyelet 14 is otherwise the same.

It will be appreciated that significant advantages can be achieved by using the scaffolding safety device of the present invention because it is easy to use in that a workman would generally be skilled in working with scaffolding clamps to adjust or move the scaffolding safety device.

Also, less scaffolding is needed to provide a safe environment in which a worker can be secured to a scaffolding structure without the need for overhead horizontal ledgers.

1. A scaffolding safety device comprises a clamping portion and an attachment portion, wherein the clamping portion is operable to be removably secured to a scaffolding pole and the attachment portion is operable to receive a tether for tethering a worker to the scaffolding safety device, and in which the clamping portion and the attachment portion are rigidly linked together.

2. A scaffolding safety device as claimed in claim 1, in which the clamping portion is an existing scaffolding clamp comprising two separate pivotally mounted clamp sections.

3. A scaffolding safety device as claimed in claim 2, in which case the attachment portion projects from one clamp section or from between the two clamp sections.

4. A scaffolding safety device as claimed in claim 1, in which the clamping portion comprises pivotable jaws which are securable to a scaffolding pole with locking means.

5. A scaffolding safety device as claimed in claim 1, in which the clamping portion is operable to be clamped between sections of the scaffolding.

6. A scaffolding safety device as claimed in claim 5, in which the clamping portion is operable to be clamped between cup portions of the scaffolding, as in a cup lock system.

7. A scaffolding safety device as claimed in claim 5, in which the clamping portion comprises a plate to be clamped relative to the scaffolding.

8. A scaffolding safety device as claimed in claim 1, in which the attachment portion comprises a closed loop.

9. A scaffolding safety device as claimed in 8, in which the closed loop has a hinged opening.

10. A scaffolding safety device as claimed in claim 1, the tether is a lanyard, attachable to a worker's harness.

11. A scaffolding safety device as claimed in claim 10, in which the lanyard is captive on the attachment portion.

12. A scaffolding safety device as claimed in claim 1, which is operable to be secured to a generally vertically orientated scaffolding pole.

13. A scaffolding safety device as claimed in claim 1, which is operable to be secured to a scaffolding pole orientated at an angle to the horizontal.

14. A scaffolding safety device as claimed in claim 1, which is operable to be secured to a generally horizontal scaffolding pole.
